(19) United States
(12) Patent Application Publication
(10) Pub. No.: US 2025/0111173 A1
(43) Pub. Date: Apr. 3, 2025

(54) Sentence Representation Generation for Cross-lingual Retrieval

(71) Applicant: Microsoft Technology Licensing, LLC, Redmond, WA (US)

(72) Inventors: Ning WU, Beijing (CN); Yaobo LIANG, Beijing (CN); Baoquan FAN, Beijing (CN); Linjun SHOU, Haidian (CN); Ming GONG, Beijing (CN); Daxin JIANG, Beijing (CN); Nan DUAN, Beijing (CN)

(21) Appl. No.: 18/834,190

(22) PCT Filed: Nov. 30, 2022
(86) PCT No.: PCT/US2022/051331

§ 371 Date: Jul. 29, 2024

(30) Foreign Application Priority Data
Mar. 4, 2022 (CN) 202210207198.5

(51) Int. Cl. G06F 40/58; G06F 16/3332

(52) U.S. Cl. CPC G06F 40/58; G06F 16/3337

(57) ABSTRACT

The present disclosure proposes a method, apparatus and computer program product for sentence representation generation for cross-lingual retrieval. A target sentence may be obtained. An initial target sentence representation of the target sentence may be generated through an encoder, the encoder pretrained through a contrastive context prediction mechanism. A target sentence representation of the target sentence for cross-lingual retrieval may be generated based on the initial target sentence representation through cross-lingual calibration.

### BACKGROUND

A Cross-lingual Dense Vector Retrieval task is an important task in natural language processing tasks. The cross-lingual dense vector retrieval task involves multiple languages, which aims to retrieve information in one language with a query in another language. For the purpose of description simplification, herein, the cross-lingual dense vector retrieval task is referred to as a cross-lingual retrieval task for short. Cross-lingual retrieval tasks may include, e.g., a Cross-lingual Natural Language Inference task, a Cross-lingual Sentence Retrieval task, a Cross-Lingual Query Passage Retrieval task, etc. When performing a cross-lingual retrieval task, a set of sentence representations for a corresponding set of sentences may be generated by an encoder, and a retrieval result may be output based on the set of generated sentence representations through a suitable prediction layer. Taking the cross-lingual query passage retrieval task as an example, this task may, for a given query in a language, retrieve a passage that can answer the query from candidate passages in another language. When performing the cross-lingual query passage retrieval task, sentence representations of the query and each sentence in the candidate passages may be generated through an encoder first, and then a retrieval result may be output based on the generated sentence representations through a prediction layer.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter. Embodiments of the present disclosure propose a method, apparatus and computer program product for sentence representation generation for cross-lingual retrieval. A target sentence may be obtained. An initial target sentence representation of the target sentence may be generated through an encoder, the encoder pretrained through a contrastive context prediction mechanism. A target sentence representation of the target sentence for cross-lingual retrieval may be generated based on the initial target sentence representation through cross-lingual calibration.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary process for sentence representation generation for cross-lingual retrieval according to an embodiment of the present disclosure.

FIG. 2 illustrates an exemplary process for pretraining an encoder through a contrastive context prediction mechanism according to an embodiment of the present disclosure.

FIG. 3 illustrates an exemplary process for obtaining a plurality of sentence pairs according to an embodiment of the present disclosure.

FIG. 4 illustrates an exemplary process for generating a sub-contrastive prediction loss based on a contrastive context prediction mechanism according to an embodiment of the present disclosure.

FIG. 5 illustrates an exemplary process for performing cross-lingual calibration according to an embodiment of the present disclosure.

FIG. 6 is a flowchart of an exemplary method for sentence representation generation for cross-lingual retrieval according to an embodiment of the present disclosure.

FIG. 7 illustrates an exemplary apparatus for sentence representation generation for cross-lingual retrieval according to an embodiment of the present disclosure.

FIG. 8 illustrates an exemplary apparatus for sentence representation generation for cross-lingual retrieval according to an embodiment of the present disclosure.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

There are various approaches for obtaining encoders capable of generating sentence representations suitable for performing a cross-lingual retrieval task. As an example, a machine learning model may be pre-trained based on a bilingual training corpus through a known pre-training mechanism, e.g., a Masked Language Model (MLM) mechanism. Herein, a bilingual training corpus may refer to a training corpus that includes a plurality of sentence pairs, and each sentence pair includes two sentences in two languages. The pretrained model may then be fine-tuned for a language. The fine-tuned model may be deployed for sentence representation generation for another language. As another example, a machine learning model may be pretrained through enabling two sentences with the same meaning but in different languages to have similar representations through a Contrastive Learning mechanism. The model pretrained in this way may be deployed, without fine-tuning, for sentence representation generation for cross-lingual retrieval. The methods described above need to rely on a bilingual training corpus. However, bilingual training corpora involving less-frequently used low-resource languages or non-English bilingual training corpora are scarce, and pretraining a model only with bilingual training corpora involving English will limit the performance of the model when performing a cross-lingual retrieval task involving other languages. Furthermore, some cross-lingual retrieval tasks, e.g., a cross-lingual query passage retrieval task, require a model to map a query and a candidate passage which are semantically relevant to the same location in an embedding space. However, existing models can only map a bilingual sentence pair with the same meaning to the same position in the embedding space, e.g., map a query in a language and a query in another language with the same meaning to the same position in the embedding space, or map a candidate passage in a language and a candidate passage in another language with the same meaning to the same position in the embedding space, but are not able to map a query and a candidate passage in the same language to the same position in the embedding space. This will also limit the performance of the model in generating sentence representations, thereby further affecting the accuracy of the cross-lingual retrieval.

Embodiments of the present disclosure propose improved sentence representation generation for cross-lingual retrieval. Firstly, an initial target sentence representation of a target sentence may be generated through an encoder pretrained according to the embodiments of the present disclosure. Herein, a sentence in a text on which a cross-lingual retrieval task is to be performed may be referred to as a target sentence. Taking a cross-lingual query passage retrieval task as an example, a target sentence may be a sentence in a query or a candidate passage. A representation of the target sentence generated by an encoder may be referred to as an initial target sentence representation. Subsequently, post-processing, e.g., cross-lingual calibration, may be performed on the initial target sentence representation, to generate a target sentence representation. The generated target sentence representation may be suitable for performing various types of cross-lingual retrieval tasks, e.g., a cross-lingual natural language inference task, a cross-lingual sentence retrieval task, a cross-lingual query passage retrieval task, etc.

In an aspect, the embodiments of the present disclosure propose to pretrain an encoder through a Contrastive Context Prediction (CCP) mechanism. The encoder may be pretrained with a training dataset including a plurality of sentence pairs. Each sentence pair may include two sentences located in the same context window from the same document. Accordingly, the two sentences may be two sentences in the same language. Herein, a context window may refer to a text segment consisting of a predetermined number of consecutive sentences in the same document. The contrastive context prediction mechanism aims to model a sentence-level contextual relationship in a document, such that representations of two sentences in a sentence pair are as close as possible to each other and as far away from randomly sampled negative samples as possible. Two sentences located in the same context window usually may be considered to have the same or similar meaning. An encoder pretrained through the contrastive context prediction mechanism may generate similar representations for two sentences with the same or similar meaning. Further, the encoder may generate similar representations for two sentences with the same or similar meaning but in different languages, thus the sentence representations of the two sentences may be automatically aligned in an embedding space. Accordingly, sentence representations of sentences in different languages generated by this encoder may form an isomorphic structure in the embedding space. An accurate retrieval result may be obtained when performing a cross-lingual retrieval task with such sentence representations. Furthermore, since various sentence pairs used to make up a training dataset are two sentences in the same language extracted from the same document, the training dataset used to pretrain the encoder may be a monolingual training corpus. Herein, a monolingual training corpus may refer to a training corpus that includes a plurality of sentence pairs, and each sentence pair includes two sentences in the same languages. It should be appreciated that the plurality of sentence pairs included in the monolingual training corpus may be in different languages. Such a monolingual training corpus is readily available and resource-rich. Accordingly, the pre-training of the encoder may be independent of resource-scarce bilingual training corpora. Through the contrastive context prediction mechanism described above, the encoder pre-trained with the monolingual training corpus may be widely applied to generate sentence representations in various languages, and the generated sentence representations may obtain accurate retrieval results when used to perform various types of cross-lingual retrieval tasks.

In another aspect, the embodiments of the present disclosure propose to employ a Language-specific Memory Bank to store a previous representation set corresponding to a previous training dataset when pretraining an encoder. Each previous representation may have a language tag indicating a language in which the sentence based on which the previous representation is generated. These previous representation sets may be used in training for a current training dataset. For example, in training for a current sentence pair, only a language-specific representation set from the previous representation set for the same language as the language of the current sentence pair may be used. A current representation set corresponding to a current training dataset may also be stored in the language-specific memory bank for future use. The use of the language-specific memory bank may effectively avoid model collapse that is prone to occur in the contrastive training of models.

In yet another aspect, the embodiments of the present disclosure propose to employ an Asymmetric Batch Normalization operation to perform batch normalization on data when pretraining an encoder. For example, when generating a prediction loss for one sentence pair in a training dataset, a batch normalization mode based on a batch mean and a batch variance may be employed for a sentence, while a batch normalization mode based on a running mean and a running variance may be employed for another sentence. Employing the asymmetric batch normalization operation may effectively avoid information leakage due to intra-batch communication among samples.

In still another aspect, the embodiments of the present disclosure propose to perform cross-lingual calibration on an initial target sentence representation output by an encoder through a number of operations. Sentence representations of sentences in different languages obtained through the encoder may have a homogeneous structure in an embedding space but are distributed in different regions in the embedding space. Through the cross-lingual calibration, sentence representations of the sentences in different languages may be further aligned in the embedding space, so as to achieve a better cross-lingual retrieval effect. The cross-lingual calibration may comprise operations such as shifting, scaling, and rotating, etc.

It should be appreciated that, although the foregoing discussion and the following discussion may involve examples of generating sentence representations suitable for performing cross-lingual retrieval tasks, the embodiments of the present disclosure are not limited to this, but may generate sentence representations suitable for performing other natural language processing tasks in a similar way.

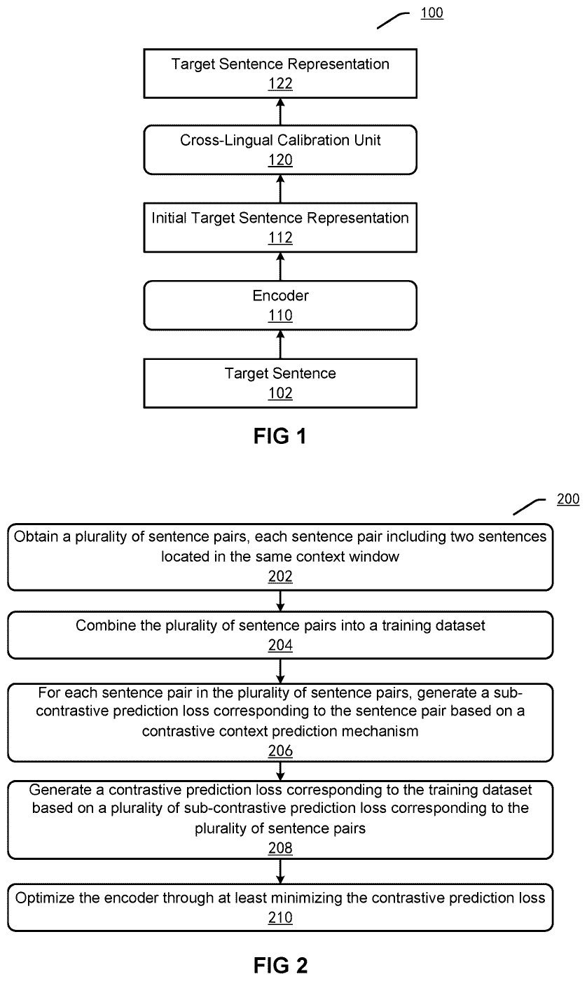

FIG. 1 illustrates an exemplary process 100 for sentence representation generation for cross-lingual retrieval according to an embodiment of the present disclosure. Through the process 100, a target sentence representation 122 of a target sentence 102 may be generated.

The target sentence 102 may be obtained. The target sentence 102 may be a sentence in a text for which a cross-lingual retrieval task is to be performed. Taking a cross-lingual query passage retrieval task as an example, the target sentence 102 may be a sentence in a query or a candidate passage. The target sentence 102 may be a sentence in any language, e.g., a sentence in a first language.

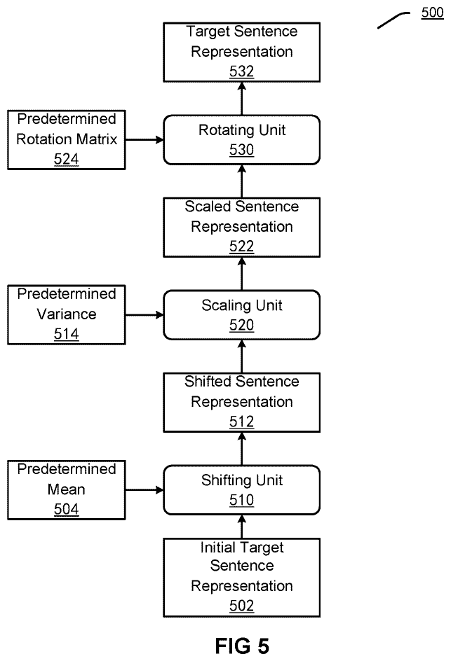

An initial target sentence representation 112 of the target sentence 102 may be generated through an encoder 110. The encoder 110 may be various types of machine learning models, e.g., a transformer structure-based model, a Long Short-Term Memory (LSTM) model, a Gated Recurrent Unit (GRU) model, etc. The encoder 110 may be pretrained through a contrastive context prediction mechanism. An exemplary process for pretraining the encoder 110 through the contrastive context prediction mechanism will be described later in conjunction with FIG. 2. Sentence representations of sentences in different languages obtained through the encoder 110 may have a homogeneous structure in an embedding space but are distributed in different regions in the embedding space. After the initial target sentence representation 112 of the target sentence 102 has been generated through the encoder 110, cross-lingual calibration may be performed on the initial target sentence representation 112, so that sentence representations of the sentences in different languages can be further aligned in the embedding space, so as to achieve a better cross-lingual retrieval effect. For example, a target sentence representation 122 of the target sentence 102 for cross-lingual retrieval may be generated based on the initial target sentence representation 112 through a cross-lingual calibration unit 120. An exemplary process for performing cross-lingual calibration will be described later in conjunction with FIG. 5. The generated target sentence representation 122 may be suitable for performing a cross-lingual retrieval task, e.g., a cross-lingual retrieval task across the first language and a second language.

It should be appreciated that the process for sentence representation generation for cross-lingual retrieval described above in conjunction with FIG. 1 is merely exemplary. Depending on actual application requirements, the steps in the process for sentence representation generation for cross-lingual retrieval may be replaced or modified in any manner, and the process may include more or fewer steps.

FIG. 2 illustrates an exemplary process 200 for pretraining an encoder through a contrastive context prediction mechanism according to an embodiment of the present disclosure. The encoder may be, e.g., the encoder 110 in FIG. 1. The encoder pretrained through the process 200, when actually deployed, may generate an initial target sentence representation of a target sentence. The encoder may be pre-trained through the contrastive context prediction mechanism with a training dataset obtained according to the embodiments of the present disclosure.

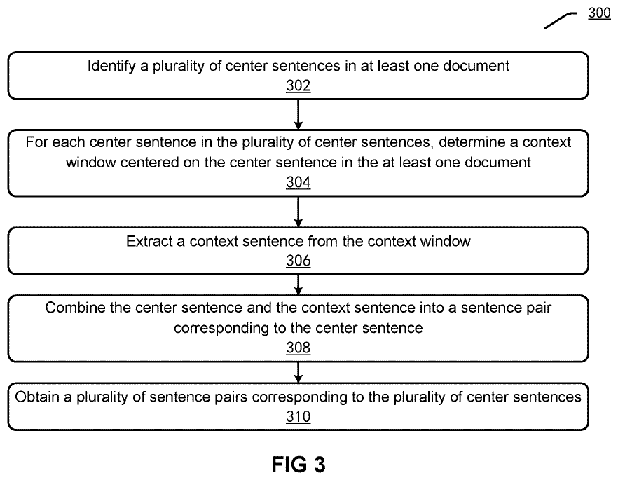

At 202, a plurality of sentence pairs may be obtained. The number of the sentence pairs may be denoted as N. Each sentence pair may include two sentences located in the same context window. Accordingly, the two sentences may be two sentences in the same language. The number of sentences included in the plurality of sentence pairs may be denoted as 2N. FIG. 3 illustrates an exemplary process 300 for obtaining a plurality of sentence pairs according to an embodiment of the present disclosure. In the process 300, a plurality of sentence pairs may be obtained through at least one document D. The obtained plurality of sentence pairs may be combined into a training dataset for pretraining an encoder.

At 302, a plurality of center sentences in at least one document D may be identified. The document D may be a sentence sequence (s₁, s₂, . . . , sₜ) consisting of a plurality of sentences, where l is the number of sentences included in the document D. A center sentence in the document D may be identified based on a predetermined radius w of a context window. Herein, a radius w may indicate the distance of sentences located at the edges of a context window from a center sentence. For example, when the radius w is 2, the distance of the sentence located at the edge of the context window from the center sentence is 2 and the size of the context window is 5. That is, there is 1 sentence between the sentence located at the edge of the context window and the center sentence. The w+1-th sentence to the w+1-th last sentence in the document D may be identified as the center sentences. For example, when the radius w is 2, the 3rd sentence to the 3rd last sentence in the document D may be identified as the center sentences.

At 304, for each center sentence in the plurality of center sentences, a context window in the document D centered on the center sentence may be determined. The center sentence may be denoted as s_{c}, and the context window centered on the center sentence s_{c} may be denoted as Context(s_{c}). For example, a context window Context(s_{c}) centered on the center sentence s_{c} in the document D may be determined based on the radius w of the context window Context (s_{c}), e.g., Context (s_{c})={sₚ|c−w≤p≤c+w, p≠c}.

At 306, a context sentence may be extracted from the context window Context (s_{c}). One sentence in a plurality of sentences in the context window other than the center sentence may be extracted as the context sentence. The extracted context sentence may be denoted as sᵢ. The encoder may model a contextual relationship between the center sentence s_{c} and its context sentence sᵢ.

At 308, the center sentence s_{c} and the context sentence sᵢ may be combined into a sentence pair (s_{c}, sᵢ) corresponding to the center sentence.

The operations of steps 304 to 308 may be performed for each center sentence in the plurality of center sentences identified at 302. At 310, a plurality of sentence pairs corresponding to the plurality of center sentences may be obtained.

Referring back to FIG. 2, at 204, the plurality of sentence pairs may be combined into a training dataset.

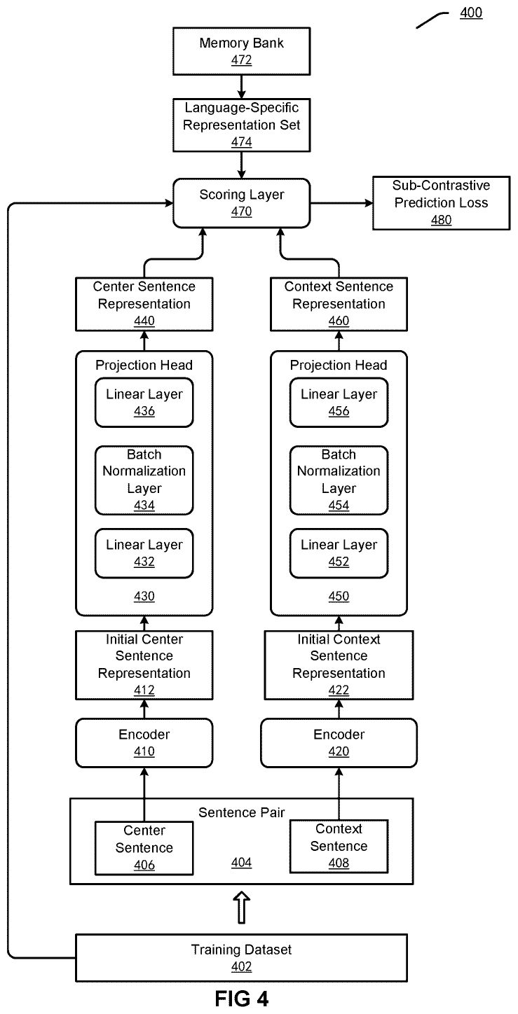

Subsequently, the encoder may be pretrained with the training dataset through a contrastive context prediction mechanism. At 206, for each sentence pair in the plurality of sentence pairs, a sub-contrastive prediction loss corresponding to the sentence pair may be generated based on the contrastive context prediction mechanism. The sub-contrastive prediction loss corresponding to the sentence pair (s_{c}, sᵢ) may be denoted as l_{c,i}^{w}. An exemplary process for generating the sub-contrastive prediction loss based on the contrastive context prediction mechanism will be described later in conjunction with FIG. 4. The contrastive context prediction mechanism aims to model a sentence-level contextual relationship in a document, such that representations of two sentences in a sentence pair are as close as possible to each other and as far away from randomly sampled negative samples as possible. Two sentences located in the same context window usually may be considered to have the same or similar meaning. An encoder pretrained through the contrastive context prediction mechanism may generate similar representations for two sentences with the same or similar meaning.

At 208, a contrastive prediction loss L_{CL} corresponding to the training dataset may be generated based on a plurality of sub-contrastive prediction loss corresponding to the plurality of sentence pairs, as shown by the following formula:

$${ℒ}_{CL} = {\sum }_{c = 1}^{2 N} {\sum }_{i = 1}^{2 N} m ( {s}_{c} , {s}_{i} ) {l}_{c , i}^{w} \qquad ( 1 )$$

where when the center sentence s_{c} and the context sentence sᵢ are located in the same context window, m(s_{c}, sᵢ)=1; and when the center sentence sᵢ and the context sentence sᵢ are not located in the same context window, m(s_{c}, sᵢ)=0.

At 210, the encoder may be optimized through at least minimizing the contrastive prediction loss L_{CL}. The encoder may be optimized by using, e.g., an Adam optimizer. Preferably, when optimizing the encoder, in addition to the contrastive prediction loss L_{CL}, other losses, e.g., a MLM loss L_{MLM} obtained based on a known MLM mechanism, may also be based on. Accordingly, a total prediction loss £ may be computed based on both the contrastive prediction loss L_{CL} and the MLM loss L_{MLM}, as shown in the following formula:

$$ℒ = {ℒ}_{CL} + {ℒ}_{MLM} \qquad ( 2 )$$

The processes 200 and 300 describe the exemplary process for pretraining the encoder through the contrastive context prediction mechanism. The encoder pretrained through the contrastive context prediction mechanism may generate similar representations for two sentences with the same or similar meaning. Further, the encoder may generate similar representations for two sentences with the same or similar meaning but in different languages, thus the sentence representations of the two sentences may be automatically aligned in an embedding space. Accordingly, the sentence representations of sentences in different languages generated by this encoder may form an isomorphic structure in the embedding space. An accurate retrieval result may be obtained when performing a cross-lingual retrieval task with such sentence representations. Furthermore, since various sentence pairs used to make up a training dataset are two sentences in the same language extracted from the same document, the training dataset used to pretrain the encoder may be a monolingual training corpus. Such a monolingual training corpus is readily available and resource-rich. Accordingly, the pre-training of the encoder may be independent of resource-scarce bilingual training corpora. Through the contrastive context prediction mechanism described above, the encoder pre-trained with the monolingual training corpus may be widely applied to generate sentence representations in various languages, and the generated sentence representations may obtain accurate retrieval results when used to perform various types of cross-lingual retrieval tasks.

It should be appreciated that the process for pretraining the encoder through the contrastive context prediction mechanism described above in conjunction with FIGS. 2 to 3 is merely exemplary. Depending on actual application requirements, the steps in the process for pretraining the encoder may be replaced or modified in any manner, and the process may include more or fewer steps. In addition, the specific orders or hierarchies of the steps in the processes 200 and 300 are merely exemplary, and the process for pretraining the encoder may be performed in an order different from the described ones.

FIG. 4 illustrates an exemplary process 400 for generating a sub-contrastive prediction loss based on a contrastive context prediction mechanism according to an embodiment of the present disclosure. The process 400 may correspond to the operation at the step 206 in FIG. 2. The process 400 may be performed for a sentence pair, e.g., a sentence pairs 404 in a training dataset 402 comprising a plurality of sentence pairs. Through the process 400, a sub-contrastive prediction loss 480 corresponding to the sentence pair 404 may be generated based on the contrastive context prediction mechanism. The sentence pair 404 may include a center sentence s_{c} and a context sentence sᵢ.

An initial center sentence representation 412 h_{c} of the center sentence 406 s_{c} may be predicted or generated through an encoder 410. For example, a corresponding representation of a token [CLS] artificially inserted in the center sentence 406 s_{c} may be used as the initial center sentence represents 412 h_{c}. Similarly, an initial context sentence representation 422 hᵢ of the context sentence 408 sᵢ may be predicted or generated through an encoder 420. For example, a corresponding representation of a token [CLS] artificially inserted in the context sentence 408 sᵢ may be used as the initial context sentence represents 422 hᵢ. The encoder 410 and the encoder 420 may, e.g., correspond to the encoder 110 in FIG. 1. The encoder 410 and the encoder 420 may be machine learning models with the same structure and shared parameters. The process described above may be as shown by the following formulas:

$${h}_{c} = f ( {s}_{c} ) \qquad ( 3 )$$

$${h}_{i} = f ( {s}_{i} ) \qquad ( 4 )$$

where f(·) represents the operation at the encoder 410 or the encoder 420.

The initial center sentence representation 412 h_{c} may be provided to a Projection Head 430. The projection head 430 may be a non-linear neural network model that may map the initial center sentence representation 412 h_{c} to a new embedding space. For example, the projection head 430 may generate a center sentence representation 440 z_{c} of the center sentence 406 s_{c} based on the initial center sentence representation 412 h_{c}. The projection head 430 may help the encoder 410 to learn a general representation without overfitting a contrastive prediction loss. The projection head 430 may include, e.g., a linear layer 432, a batch normalization layer 434, a linear layer 436, etc. Similarly, the initial context sentence representation 422 hᵢ may be provided to a projection head 450. The projection head 450 may have a similar function and structure as the projection head 430. The projection head 450 may generate a context sentence representation 460 zᵢ of the context sentence 408 sᵢ based on the initial context sentence representation 422 hᵢ. The projection head 450 may include, e.g., a linear layer 452, a batch normalization layer 454, a linear layer 456, etc.

The linear layer 432 and the linear layer 452 may have the same structure and share parameters. The linear layer 436 and the linear layer 456 may have the same structure and share parameters. In contrast, the batch normalization layer 434 and the batch normalization layer 454 may be in different batch normalization modes at the same time. The different batch normalization modes may comprise, e.g., a training mode based on a batch mean and a batch variance, and an evaluation mode based on a running mean and a running variance. The modes of the batch normalization layer 434 and the batch normalization layer 454 may alternate between these two batch normalization modes, but need to be different from each other. For example, the batch normalization layer 454 may be in the evaluation mode when the batch normalization layer 434 is in the training mode; and the batch normalization layer 454 may be in the training mode when the batch normalization layer 434 is the evaluation mode. This manner of operation of the batch normalization layer 434 and the batch normalization layer 454 may be referred to as an asymmetric batch normalization manner. By causing the batch normalization layer 434 and the batch normalization layer 454 to operate in the asymmetric batch normalization manner, information leakage due to intra-batch communication among samples, which is prone to occur in the contrastive training of models, may be avoided. Compared with the existing Shuffle Batch Normalization, the asymmetric batch normalization according to the embodiments of the present disclosure is easier to implement and has better effects. The process of generating the center sentence representation 440 z_{c} and the context sentence representation 460 zᵢ may be as shown by the following formulas:
or

$${z}_{c} = {g}_{c} ( {h}_{c} ) = g ( ) \cdot train ( ) ; and {z}_{i} = {g}_{i} ( {h}_{i} ) = g ( ) \cdot eval ( ) \qquad ( 5 )$$

$${z}_{c} = {g}_{c} ( {h}_{c} ) = g ( ) \cdot eval ( ) ; and {z}_{i} = {g}_{i} ( {h}_{i} ) = g ( ) \cdot train ( ) \qquad ( 6 )$$

where g_{c}(·) represents the operation at the projection head 430, gᵢ(·) represents the operation at the projection head 450, g( ). train( ) indicates in the training mode, and g( ). eval( ) indicates in the evaluation mode.

After the center sentence representation 440 z_{c} and the context sentence representation 460 zᵢ are obtained, a sub-contrastive prediction loss 480 l_{c,i}^{w} may be generated based at least on the center sentence representation 440 z_{c} and the context sentence representation 460 zᵢ. Preferably, a previous representation set corresponding to a previous training dataset may be additionally considered when generating the sub-contrastive prediction loss l_{c,i}^{w}. The previous representation set corresponding to the previous training dataset may be stored in a memory bank 472. The memory bank 472 may be a language-specific memory bank. Each previous representation stored in the memory bank 472 may have a language tag indicating a language in which the sentence based on which the previous representation is generated. The memory bank 472 may be maintained in a First-In-First-Out (FIFO) manner. The previous representation set stored in the memory bank 472 may be used in training for a current training dataset, e.g., the training dataset 402. In training for a current sentence pair, only a language-specific representation set from the previous representation set for the same language as the language of the current sentence pair may be used. A language of the sentence pair 404 including the center sentence 406 s_{c} and the context sentence 408 sᵢ may be denoted as lg(i). A language-specific representation set 474 M_{lg(i)} for the language lg(i) may be extracted from the previous representation set in the memory bank 472.

Subsequently, a sub-contrastive prediction loss 480 l_{c,i}^{w} may be generated based at least on the center sentence representation 440 z_{c}, the context sentence representation 460 zᵢ, and the language-specific representation set 474 M_{lg(i)}. The language-specific representation set 474 M_{lg(i)} may be used as negative samples to participate in the computation of the sub-contrastive prediction loss 480 l_{c,i}^{w}. The use of the language-specific memory bank may effectively avoid model collapse that is prone to occur in the contrastive training of models. In addition, representations corresponding to other sentences in the training dataset 402 may also be considered when generating the sub-contrastive prediction loss 480 l_{c,i}^{w}. The process of generating the sub-contrastive prediction loss 480 l′, may be as shown by the following formula:

$${l}_{c , i}^{w} = - log \frac{exp ( cos ( {z}_{c} , {z}_{i} ) / τ )}{{\sum }_{k = 1}^{2 N + {M}_{l g ( i )}} {𝕀}_{[ k \neq c ]} exp ( cos ( {z}_{c} , {z}_{k} ) / τ )} \qquad ( 7 )$$

where τ is a hyper parameter represents the temperature.

Preferably, the center sentence representation 440 z_{c} and the context sentence representation 460 zᵢ may be stored into the memory bank 472, e.g., into a current representation set corresponding to the training dataset 402 in the memory bank 472, for future use when pretraining the encoder with a subsequent training dataset. When the number of representations stored in the memory bank 472 exceeds its capacity limit, oldest representations in the memory bank 472 may be deleted. In addition, the projection head 430 and the projection head 450 may only be used when computing the sub-contrastive prediction loss in the pretraining stage of the encoders 410 and 420. After the pretraining stage, the projection head 430 and the projection head 450 may be discarded. It should be appreciated that the process for generating the sub-contrastive prediction loss based the contrastive context prediction mechanism described above in conjunction with FIG. 4 is merely exemplary. Depending on actual application requirements, the steps in the process for generating the sub-contrastive prediction loss may be replaced or modified in any manner, and the process may include more or fewer steps. In addition, the specific order or hierarchy of the steps in the process 400 is merely exemplary, and the process for generating the sub-contrastive prediction loss may be performed in an order different from the described one.

Referring back to FIG. 1, after an initial target sentence representation of a target sentence is generated through an encoder, a target sentence representation of the target sentence for cross-lingual retrieval may be generated based on the initial target sentence representation through cross-lingual calibration. Sentence representations of sentences in different languages obtained through the encoder may have a homogeneous structure in an embedding space but are distributed in different regions in the embedding space. Through the cross-lingual calibration, sentence representations of the sentences in different languages may be further aligned in the embedding space, so as to achieve a better cross-lingual retrieval effect. The cross-lingual calibration may comprise operations such as shifting, scaling, and rotating, etc. The target sentence may be a sentence in a first language. The target sentence representation may be suitable for performing, e.g., a cross-lingual retrieval task across the first language and a second language. When performing a shifting operation, a predetermined mean may be subtracted from a current sentence representation. The predetermined mean may be computed based on a set of representations corresponding to a set of sentences in the first language. The set of sentences may be extracted from a predetermined corpus. When performing a scaling operation, a current sentence representation may be divided by a predetermined variance. The predetermined variance may be computed based on a set of representations corresponding to a set of sentences in the first language. When performing a rotating operation, a current sentence representation may be rotated based on a predetermined rotation matrix between the first language and the second language. The predetermined rotation matrix may be an orthogonal rotation matrix, which may be learned through a known unsupervised method from a corpus involving sentence representations in the first language and sentence representations in the second language.

FIG. 5 illustrates an exemplary process 500 for performing cross-lingual calibration according to an embodiment of the present disclosure. The process 500 may correspond to the operation at the cross-lingual calibration unit 120 in FIG. 1. Through the process 500, a target sentence representation 532 may be generated based on an initial target sentence representation 502. The initial target sentence representation 502 may correspond to the initial target sentence representation 112 in FIG. 1, and the target sentence representation 532 may correspond to the target sentence representation 122 in FIG. 1. The target sentence may be denoted as sₜ. A language of the target sentence sₜ may be denoted as lg(t). The target sentence representation may be suitable for performing a cross-lingual retrieval task across the language lg(t) and another language, e.g., language lg(j).

The initial target sentence representation 502 may be denoted as hₜ⁰. The initial target sentence representation 502 he may be provided to a shifting unit 510. A predetermined mean value 504 μ_{lg(t)} may be subtracted from the initial target sentence representation 502 hₜ⁰ through the shifting unit 510, to obtain a shifted sentence representation 512 hₜ¹. The predetermined mean value 504 μ_{lg(t)} may be computed based on a set of representations corresponding to a set of sentences in the language of lg(t). The set of sentences may be extracted from a predetermined corpus. The process may be as shown by the following formula:

$${h}_{t}^{1} = {h}_{t}^{0} - {μ}_{l g ( t )} \qquad ( 8 )$$

Subsequently, the shifted sentence representation 512 hₜ¹ may be provided to a scaling unit 520. The shifted sentence representation 512 hₜ¹ may be divided by a predetermined variance 514 σ_{lg(t)} through the scaling unit 520, to obtain a scaled sentence representation 522 hₜ². The predetermined variance 514 σ_{lg(t)} may be computed based on a set of representations corresponding to a set of sentences in the language of lg(t). The process may be as shown by the following formula:

$${h}_{t}^{2} = \frac{{h}_{t}^{1}}{{σ}_{l g ( t )}} \qquad ( 9 )$$

Next, the scaled sentence representation 522 hₜ² may be provided to a rotating unit 530. The scaled sentence representation 522 hₜ² may be rotated through the rotating unit 530 based on a predetermined rotation matrix W_{t,j} between the language lg(t) and the language lg(j), to obtain a target sentence representation 532 hₜ³. The predetermined rotation matrix W_{t,j} may be learned from a corpus involving sentence representations in the language of lg(t) and sentence representations in the language of lg(j) through a known unsupervised method. The process may be as shown by the following formula:

$${h}_{t}^{3} = {h}_{t}^{2} {W}_{t , j} \qquad ( 10 )$$

It should be appreciated that the process for performing the cross-lingual calibration described above in conjunction with FIG. 1 is merely exemplary. Depending on actual application requirements, the steps in the process for performing the cross-lingual calibration may be replaced or modified in any manner, and the process may include more or fewer steps. For example, although in the process 500, three operations of shifting, scaling, and rotating are employed to generate the target sentence representation, in some embodiments, only one or two operations of shifting, scaling, and rotating may be employed to generate the target sentence representation. In addition, the specific order or hierarchy of the steps in the process 500 is merely exemplary, and the process for the cross-lingual calibration may be performed in an order different from the described one.

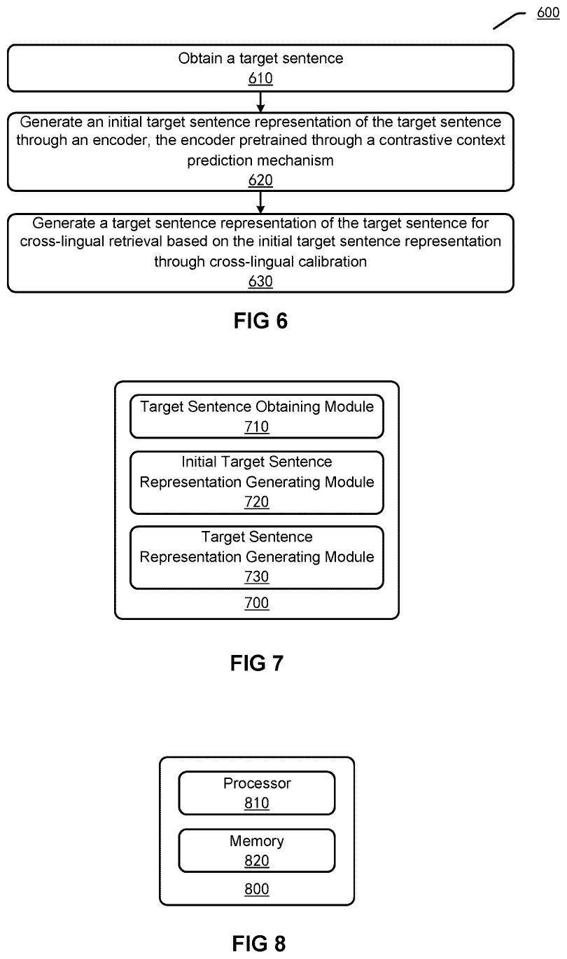

FIG. 6 is the flowchart of an exemplary method 600 for sentence representation generation for cross-lingual retrieval according to an embodiment of the present disclosure.

At 610, a target sentence may be obtained.

At 620, an initial target sentence representation of the target sentence may be generated through an encoder. The encoder may be pretrained through a contrastive context prediction mechanism.

At 630, a target sentence representation of the target sentence for cross-lingual retrieval may be generated based on the initial target sentence representation through cross-lingual calibration. In an implementation, the target sentence may be a sentence in a first language. The target sentence representation may be suitable for performing a cross-lingual retrieval task across the first language and a second language.

In an implementation, a pretraining of the encoder may comprise: pretraining the encoder through the contrastive context prediction mechanism with a training dataset. The training dataset may be obtained through: obtaining a plurality of sentence pairs, each sentence pair including two sentences located in the same context window; and combining the plurality of sentence pairs into the training dataset.

The two sentences may be two sentences in the same language.

The obtaining a plurality of sentence pairs may comprise: identifying a plurality of center sentences in at least one document; for each center sentence in the plurality of center sentences, determining a context window centered on the center sentence in the at least one document, extracting a context sentence from the context window, and combining the center sentence and the context sentence into a sentence pair corresponding to the center sentence; and obtaining the plurality of sentence pairs corresponding to the plurality of center sentences.

The pretraining the encoder may comprise: for each sentence pair in the plurality of sentence pairs, generating a sub-contrastive prediction loss corresponding to the sentence pair based on the contrastive context prediction mechanism; generating a contrastive prediction loss corresponding to the training dataset based on a plurality of sub-contrastive prediction loss corresponding to the plurality of sentence pairs; and optimizing the encoder through at least minimizing the contrastive prediction loss.

The sentence pair may include a center sentence and a context sentence. The generating a sub-contrastive prediction loss corresponding to the sentence pair based on the contrastive context prediction mechanism may comprise: predicting an initial center sentence representation of the center sentence through the encoder; predicting an initial context sentence representation of the context sentence through the encoder; generating a center sentence representation of the center sentence based on the initial center sentence representation through a first projection head; generating a context sentence representation of the context sentence based on the initial context sentence representation through a second projection head; and generating the sub-contrastive prediction loss based at least on the center sentence representation and the context sentence representation.

The first projection head may include at least a first batch normalization layer. The second projection head may include at least a second batch normalization layer. The first batch normalization layer and the second batch normalization layer may be in different batch normalization modes at the same time.

The different batch normalization modes may comprise: a training mode based on a batch mean and a batch variance, and an evaluation mode based on a running mean and a running variance. The center sentence and the context sentence may be sentences in a third language. A previous representation set corresponding to a previous training dataset may be stored in a memory bank. The generating the sub-contrastive prediction losses may comprise: extracting a language-specific representation set for the third language from the previous representation set; and generating the sub-contrastive prediction loss based at least on the center sentence representation, the context sentence representation, and the language-specific representation set.

The method 600 may further comprise: storing the center sentence representation and the context sentence representation in a current representation set corresponding to the training dataset in a memory bank.

In an implementation, the generating a target sentence representation may comprise: generating the target sentence representation through performing, on the initial target sentence representation, at least one of shifting, scaling, and rotating.

The target sentence may be a sentence in a first language. The shifting may comprise: subtracting a predetermined mean from a current sentence representation, the predetermined mean computed based on a set of representations corresponding to a set of sentences in the first language. The target sentence may be a sentence in a first language. The scaling may comprise: dividing a current sentence representation by a predetermined variance, the predetermined variance computed based on a set of representations corresponding to a set of sentences in the first language.

The target sentence may be a sentence in a first language. The target sentence representation may be used for performing a cross-lingual retrieval task across the first language and a second language. The rotating may comprise: rotating a current sentence representation based on a predetermined rotation matrix between the first language and the second language.

It should be appreciated that the method 600 may further comprise any step/process for sentence representation generation for cross-lingual retrieval according to the embodiments of the present disclosure as mentioned above.

FIG. 7 illustrates an exemplary apparatus 700 for sentence representation generation for cross-lingual retrieval according to an embodiment of the present disclosure.

The apparatus 700 may comprise: a target sentence obtaining module 710, for obtaining a target sentence; an initial target sentence representation generating module 720, for generating an initial target sentence representation of the target sentence through an encoder, the encoder pretrained through a contrastive context prediction mechanism; and a target sentence representation generating module 730, for generating a target sentence representation of the target sentence for cross-lingual retrieval based on the initial target sentence representation through cross-lingual calibration. Moreover, the apparatus 700 may further comprise any other modules configured for sentence representation generation for cross-lingual retrieval according to the embodiments of the present disclosure as mentioned above.

FIG. 8 illustrates an exemplary apparatus 800 for sentence representation generation for cross-lingual retrieval according to an embodiment of the present disclosure.

The apparatus 800 may comprise at least one processor 810 and a memory 820 storing computer-executable instructions. The computer-executable instructions, when executed, may cause the at least one processor 810 to: obtain a target sentence; generate an initial target sentence representation of the target sentence through an encoder, the encoder pretrained through a contrastive context prediction mechanism; and generate a target sentence representation of the target sentence for cross-lingual retrieval based on the initial target sentence representation through cross-lingual calibration.

In an implementation, the target sentence may be a sentence in a first language. The target sentence representation may be suitable for performing a cross-lingual retrieval task across the first language and a second language.

A pretraining of the encoder may comprise: pretraining the encoder through the contrastive context prediction mechanism with a training dataset. The training dataset may be obtained through: obtaining a plurality of sentence pairs, each sentence pair including two sentences located in the same context window; and combining the plurality of sentence pairs into the training dataset. The pretraining the encoder may comprise: for each sentence pair in the plurality of sentence pairs, generating a sub-contrastive prediction loss corresponding to the sentence pair based on the contrastive context prediction mechanism; generating a contrastive prediction loss corresponding to the training dataset based on a plurality of sub-contrastive prediction loss corresponding to the plurality of sentence pairs; and optimizing the encoder through at least minimizing the contrastive prediction loss.

It should be appreciated that the processor 810 may further perform any other steps/processes of the method for sentence representation generation for cross-lingual retrieval according to the embodiments of the present disclosure as mentioned above.

The embodiments of the present disclosure propose a computer program product for sentence representation generation for cross-lingual retrieval, comprising a computer program that is executed by at least one processor for: obtaining a target sentence; generating an initial target sentence representation of the target sentence through an encoder, the encoder pretrained through a contrastive context prediction mechanism; and generating a target sentence representation of the target sentence for cross-lingual retrieval based on the initial target sentence representation through cross-lingual calibration. In addition, the computer program may further be performed for implementing any other steps/processes of the method for sentence representation generation for cross-lingual retrieval according to the embodiments of the present disclosure as mentioned above. The embodiments of the present disclosure may be embodied in a non-transitory computer-readable medium. The non-transitory computer readable medium may comprise instructions that, when executed, cause one or more processors to perform any operation of the method for sentence representation generation for cross-lingual retrieval according to the embodiments of the present disclosure as mentioned above.

It should be appreciated that all the operations in the methods described above are merely exemplary, and the present disclosure is not limited to any operations in the methods or sequence orders of these operations, and should cover all other equivalents under the same or similar concepts. In addition, the articles “a” and “an” as used in this specification and the appended claims should generally be construed to mean “one” or “one or more” unless specified otherwise or clear from the context to be directed to a singular form.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured for performing the various functions described throughout the present disclosure. The functionality of a processor, any portion of a processor, or any combination of processors presented in the present disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are expressly incorporated herein and intended to be encompassed by the claims.

1. A method for sentence representation generation for cross-lingual retrieval, comprising:
obtaining a target sentence;
generating an initial target sentence representation of the target sentence through an encoder, the encoder pretrained through a contrastive context prediction mechanism; and
generating a target sentence representation of the target sentence for cross-lingual retrieval based on the initial target sentence representation through cross-lingual calibration.

2. The method of claim 1, wherein the target sentence is a sentence in a first language, and the target sentence representation is suitable for performing a cross-lingual retrieval task across the first language and a second language.

3. The method of claim 1, wherein a pretraining of the encoder comprises:
pretraining the encoder through the contrastive context prediction mechanism with a training dataset, wherein the training dataset is obtained through:
obtaining a plurality of sentence pairs, each sentence pair including two sentences located in the same context window; and
combining the plurality of sentence pairs into the training dataset.

4. The method of claim 3, wherein the two sentences are two sentences in the same language.

5. The method of claim 3, wherein the obtaining a plurality of sentence pairs comprises:
identifying a plurality of center sentences in at least one document;
for each center sentence in the plurality of center sentences, determining a context window centered on the center sentence in the at least one document, extracting a context sentence from the context window, and combining the center sentence and the context sentence into a sentence pair corresponding to the center sentence; and
obtaining the plurality of sentence pairs corresponding to the plurality of center sentences.

6. The method of claim 3, wherein the pretraining the encoder comprises:
for each sentence pair in the plurality of sentence pairs, generating a sub-contrastive prediction loss corresponding to the sentence pair based on the contrastive context prediction mechanism;
generating a contrastive prediction loss corresponding to the training dataset based on a plurality of sub-contrastive prediction loss corresponding to the plurality of sentence pairs; and
optimizing the encoder through at least minimizing the contrastive prediction loss.

7. The method of claim 6, wherein the sentence pair includes a center sentence and a context sentence, and the generating a sub-contrastive prediction loss corresponding to the sentence pair based on the contrastive context prediction mechanism comprises:
predicting an initial center sentence representation of the center sentence through the encoder;
predicting an initial context sentence representation of the context sentence through the encoder;
generating a center sentence representation of the center sentence based on the initial center sentence representation through a first projection head;
generating a context sentence representation of the context sentence based on the initial context sentence representation through a second projection head; and
generating the sub-contrastive prediction loss based at least on the center sentence representation and the context sentence representation.

8. The method of claim 7, wherein the first projection head includes at least a first batch normalization layer, the second projection head includes at least a second batch normalization layer, and the first batch normalization layer and the second batch normalization layer are in different batch normalization modes at the same time.

9. The method of claim 7, wherein the center sentence and the context sentence are sentences in a third language, a previous representation set corresponding to a previous training dataset is stored in a memory bank, and the generating the sub-contrastive prediction losses comprises:
extracting a language-specific representation set for the third language from the previous representation set; and
generating the sub-contrastive prediction loss based at least on the center sentence representation, the context sentence representation, and the language-specific representation set.

10. The method of claim 1, wherein the generating a target sentence representation comprises:
generating the target sentence representation through performing, on the initial target sentence representation, at least one of shifting, scaling, and rotating.

11. The method of claim 10, wherein the target sentence is a sentence in a first language, and the shifting comprises:
subtracting a predetermined mean from a current sentence representation, the predetermined mean computed based on a set of representations corresponding to a set of sentences in the first language.

12. The method of claim 10, wherein the target sentence is a sentence in a first language, and the scaling comprises:
dividing a current sentence representation by a predetermined variance, the predetermined variance computed based on a set of representations corresponding to a set of sentences in the first language.

13. The method of claim 10, wherein the target sentence is a sentence in a first language, the target sentence representation is to be used for performing a cross-lingual retrieval task across the first language and a second language, and the rotating comprises:
rotating a current sentence representation based on a predetermined rotation matrix between the first language and the second language.

14. An apparatus for sentence representation generation for cross-lingual retrieval, comprising:
at least one processor; and
a memory storing computer-executable instructions that, when executed, cause the at least one processor to:
obtain a target sentence,
generate an initial target sentence representation of the target sentence through an encoder, the encoder pretrained through a contrastive context prediction mechanism, and
generate a target sentence representation of the target sentence for cross-lingual retrieval based on the initial target sentence representation through cross-lingual calibration.

15. A computer program product for sentence representation generation for cross-lingual retrieval, comprising a computer program that is executed by at least one processor for:
obtaining a target sentence;
generating an initial target sentence representation of the target sentence through an encoder, the encoder pretrained through a contrastive context prediction mechanism; and
generating a target sentence representation of the target sentence for cross-lingual retrieval based on the initial target sentence representation through cross-lingual calibration.
